(19) United States
(12) Patent Application Publication
(10) Pub. No.: US 2025/0167375 A1
(43) Pub. Date: May 22, 2025

(54) Battery Cell Assembly with Improved Housing

(71) Applicant: Robert Bosch GmbH, Stuttgart (DE)

(72) Inventor: Florian Kneer, Duernau (DE)

(21) Appl. No.: 18/950,014

(22) Filed: Nov. 16, 2024

(30) Foreign Application Priority Data
Nov. 22, 2023 (DE) 10 2023 211 615.4

(51) Int. Cl. H01M 50/262; H01M 50/213; H01M 50/242; H01M 50/247; H01M 50/271

(52) U.S. Cl. CPC H01M 50/262; H01M 50/213; H01M 50/242; H01M 50/247; H01M 50/271; H01M 2220/30

(57) ABSTRACT

A battery cell assembly includes (i) at least one battery cell, (ii) a cell holder element at least partially enclosing the battery cell, and (iii) a multi-part housing configured for receiving the battery cell, wherein the housing includes at least a first housing part, in particular a side part, and a second housing part, in particular an interface housing part or a cover. The first housing part includes a first interlocking element, the second housing part includes a second interlocking element, and the cell holder element includes a third interlocking element which are configured to form a positive-locking connection with each other. At least one of the interlocking elements, in particular the second interlocking element, is configured as the protruding interlocking element, and wherein the protruding interlocking element engages in the two other interlocking elements.

This application claims priority under 35 U.S.C. §119 to patent application no. DE 2023 211 615.4, filed on Nov. 22, 2023 in Germany, the disclosure of which is incorporated herein by reference in its entirety

### BACKGROUND

The present disclosure relates to a battery cell assembly with an improved housing, in particular with respect to shock or impact.

Battery cell housings are known from the prior art in a variety of embodiments. The housing of a battery cell assembly is typically formed in multiple parts with a cover and optionally a plurality of side parts or a bottom plate. A guide arrangement, e.g. rails or the like, is often provided on the housing in order to be able to insert the battery cell assembly into an electrical consumer, for example an electrical tool or the like. The individual parts of the housing of the battery cell assembly are typically connected to each other by way of screws. In the event of an overload, e.g. if the battery cell assembly falls from a great height, the housing or housing parts may become detached from the rest of the battery cell assembly depending on the height of the fall and the position of impact on a surface. It would therefore be desirable to have a battery cell assembly with improved impact resistance and robustness.

### SUMMARY

The battery cell assembly according to the disclosure with the features set forth below has the advantage that a housing can be mounted more securely to the battery cell assembly. As a result, the robustness of the battery cell assembly can be increased and damage to or loosening of housing parts of the housing of the battery cell assembly can be prevented, in particular in the event of a fall from a great height onto a surface. According to the disclosure, this is achieved by the battery cell assembly comprising at least one battery cell, in particular a rotary cell, a cell holder element, in particular a heat sink element, and a multi-part housing. The battery cell is at least partially enclosed, preferably around its entire circumference, by the cell holder element. The multi-part housing is configured for receiving the battery cell and the cell holder element. The multi-part housing comprises at least a first housing part, in particular a first side part, and a second housing part, in particular an interface housing part or a cover. The second housing part preferably comprises guide areas, in particular guide rails and guide grooves, which are configured for connection to an electrical device. The electric device is in particular an electric machine, for example in an electric bicycle, an electric drive, or an electric drive in hand tools. The guide areas are preferably arranged on the cover, but can also be arranged on other housing parts, for example the first housing part. The first housing part comprises a first interlocking element, the second housing part comprises a second interlocking element and the cell holder part comprises a third interlocking element. The interlocking elements are configured to provide a positive locking connection with each other. That is to say, that at least one of the interlocking elements can be connected to the two other interlocking elements in a positive locking manner. At least one of the interlocking elements, in particular the second interlocking element on the second housing part, is configured as a protruding interlocking element, wherein the protruding interlocking element engages in the two other interlocking elements. The other two interlocking elements are preferably depressions or openings. The two other interlocking elements are preferably provided as complementary openings. The protruding interlocking element thus runs through the two openings on the second housing part and on the cell holder element. As a result, additional fixation of the first housing part can be realized, in particular on the cell holder element.

Due to the idea according to the disclosure, it is in particular possible that the battery cell assembly need not comprise additional reinforcements on guide regions and/or guide grooves, which are in particular arranged on the cover of the battery cell assembly. Thus, the interfaces to electrical devices on the battery cell assembly, some of which have existed for years, can remain unchanged and the battery cell assembly can still have a more robust construction.

Preferred further developments of the disclosure are also set forth below.

Preferably, at least one of the interlocking elements comprises a reinforcing element, in particular an insert made of metal or metal sheet. This can provide additional security and reinforcement of the interlocking elements.

Further preferably, the cell holder element as the third interlocking element comprises a protruding flange with a first opening and the second housing part comprises a second opening as the second interlocking element. The first housing part comprises a protruding element as the first interlocking element formed complementarily to the first opening and the second opening, which is received in the first opening and the second opening. This makes it possible to realize a particularly simple and compact design.

Preferably, the first opening of the cell holder element is a, in particular polygonal, through-opening, in particular quadrilateral through-opening. Further preferably, the second opening on the second housing part is also a, in particular polygonal, through-opening, preferably quadrilateral through-opening.

Particularly preferably, the cross sections of the first and second openings are the same. This ensures that the protruding element, which is received in the two openings, distributes forces equally on the cell holder element and the cover when a load is applied. This avoids load peaks, such as when the battery cell assembly falls down.

The protruding element of the first housing part preferably comprises a rib, in particular having a polygonal, in particular quadrilateral, cross section. It should be noted that the protruding element can also comprise a plurality of ribs, which have the same and/or different cross sections. Accordingly, a plurality of first and second openings are then formed in the second housing part or in the cell holder element.

Further preferably, the second housing part comprises a protruding edge in which the second opening is formed. An undercut is preferably additionally formed on the protruding edge, which is arranged between the cell holder element and the rib of the first housing part. The undercut significantly increases a load capacity of the connection of the housing parts.

For an even more secure and robust connection, a latching connection is preferably formed between a free end of the first protruding interlocking element of the first housing part and the second housing part and/or the cell holder element. The latching connection is, for example, a latching lug with a starting slope, which latches in an end position after the first housing part has been fully assembled. In order to release the connection between the first housing part and the second housing part and the cell holder element, the latching connection must then be released in order to be able to separate the parts from each other.

Further preferably, a screw connection arrangement is provided between the first housing part and the second housing part. The screw connection arrangement comprises a plurality of screw connections, which preferably can be screwed into screw-in openings in the cell holder element. It is also possible that a screw of the screw connection is additionally passed through an opening in the second housing part. Thus, an additional connection in components is achieved, further reinforcing the robustness of the battery cell assembly.

Further preferably, the connection between the cell holder element, the second housing part and the first housing part is provided adhesive-free. This results on the one hand in a cost advantage because no additional secondary substances such as adhesive or the like are required by the connection arrangement according to the disclosure. The idea according to the disclosure can also improve the quality of the battery cell assembly, which in particular also increases the satisfaction of users of the battery cell assembly by increasing the service life.

Preferably, the housing of the battery cell assembly also comprises a third housing part in addition to the first and second housing parts, wherein the connection between the third housing part, the cell holder element and the second housing part is arranged in the same manner as the first housing part. The first and third housing portions are preferably side parts of the battery cell assembly. It should further be noted that the housing may also comprise a bottom part, wherein a connection between the bottom part, the cell holder element and the first and/or second housing part is arranged in the same manner as described above.

Preferably, the component(s), in particular the side parts, the heat sink and/or the guide rail, are each made of different plastic materials. These different components thus have different mechanical characteristics. Individual adaptation of the battery cell assembly to different external boundary conditions is thus possible. For example, the guide rails may be made from a more stable plastic than the side parts.

Further preferably, a distance between the second interlocking element and a guide area of the battery cell assembly on the second housing part is at most as large as five times, in particular three times, the height of the second interlocking element. Preferably, the distance between the second interlocking element and the guide area is a maximum of 30 mm, in particular a maximum of 20 mm and in particular a maximum of 10 mm.

### BRIEF DESCRIPTION OF THE DRAWINGS

Exemplary embodiments of the disclosure are preferably explained in detail below with reference to the accompanying drawings. The drawing shows:

FIG. 1 a schematic exploded view of a battery cell assembly according to a first exemplary embodiment of the disclosure,

FIG. 2 a perspective view of a battery cell with a heat sink element of FIG. 1,

FIG. 3 a schematic, perspective interior view of a side part of the battery cell assembly of FIG. 1,

FIG. 4 a schematic perspective view of a cover of the battery cell assembly of FIG. 1,

FIG. 5 a schematic cross-sectional view of the battery cell assembly of FIG. 1,

FIG. 6 an enlarged partial sectional view of the battery cell assembly of FIG. 1 in the connection area between the heat sink and housing components, and

FIG. 7 a partial sectional view according to FIG. 6 with a tensile load, and

FIG. 8 a schematic partial sectional view of a connection area of a battery cell assembly according to a second exemplary embodiment of the disclosure.

### DETAILED DESCRIPTION

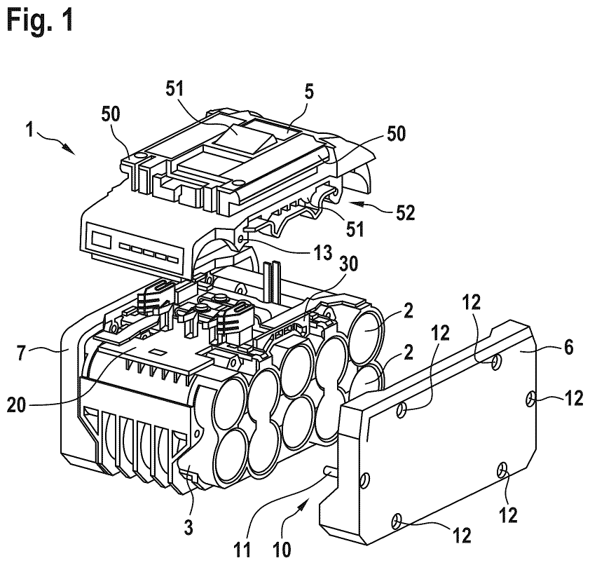

Referring to FIGS. 1 to 7, a battery cell assembly 1 according to a first preferred exemplary embodiment of the disclosure will be described in detail below.

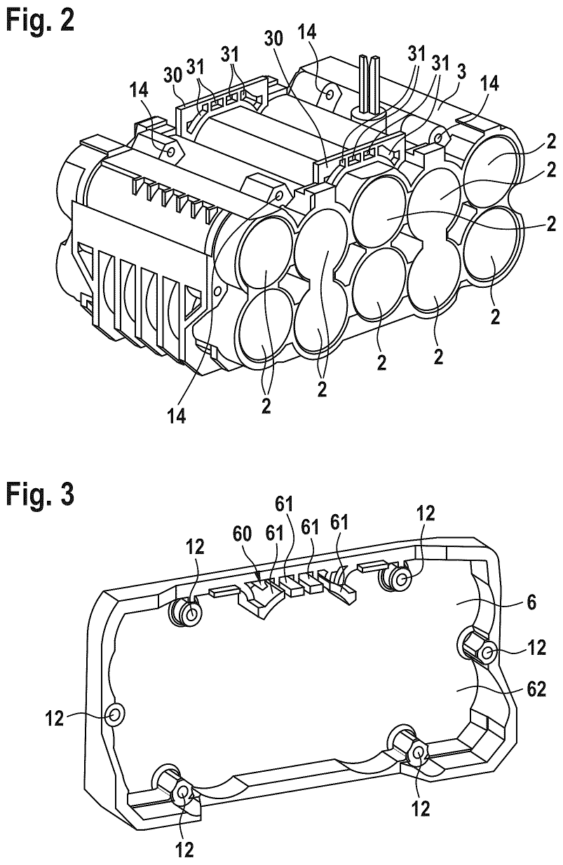

As can be seen from FIG. 1, the battery cell assembly 1 comprises a plurality of battery cells 2 surrounded by a cell holder element in the form of a heat sink element 3. The battery cells 2 are round cells in this exemplary embodiment. The heat sink element 3 encloses the round cells on a circumference and between the individual round cells, which can be seen in detail in FIG. 2.

The battery cell assembly 1 further comprises a multi-part housing 4. The housing of this exemplary embodiment comprises a first side part 6 (first housing part), a second side part 7 (third housing part) and a cover 5 (second housing part). The housing 4 of the battery cell assembly thus does not enclose all parts of the heat sink element 3, such that the heat sink element 3 is at least partially exposed and visible. By this, improved thermal management can be achieved.

Furthermore, as shown in FIG. 1, a battery management system 20 for controlling and/or regulating the battery cells is arranged on the heat sink element 3. The battery management system 20 is completely covered and protected by the cover 5.

Guide areas 50 in the form of rails and neighboring grooves are also arranged on the cover 5. The battery cell assembly can thereby be inserted into correspondingly configured counter-rails on an electrical consumer, for example a power tool. A spring-preloaded latching element 51 is further provided on the cover 5, which allows the battery cell assembly on the electrical consumer to be locked.

As can be seen in detail from FIG. 2, the heat sink element 3 comprises a protruding flange 30. The protruding flange 30 is arranged perpendicular to a surface of the heat sink element 3. As can be seen from FIG. 2, a respective protruding flange 30 is provided on a first side of the battery cell assembly to which the first side part 6 is fixed and on a second side of the battery cell assembly in which the second side part 7 is fixed.

The protruding flange 30 comprises a plurality of first openings 31 (third interlocking elements). In this exemplary embodiment, a total of four first openings 31 are provided in the protruding flange 30. The openings each have a rectangular cross-section, wherein the rectangular cross-section of the first openings 31 is configured differently. Overall, however, the two protruding flanges 30 are the same.

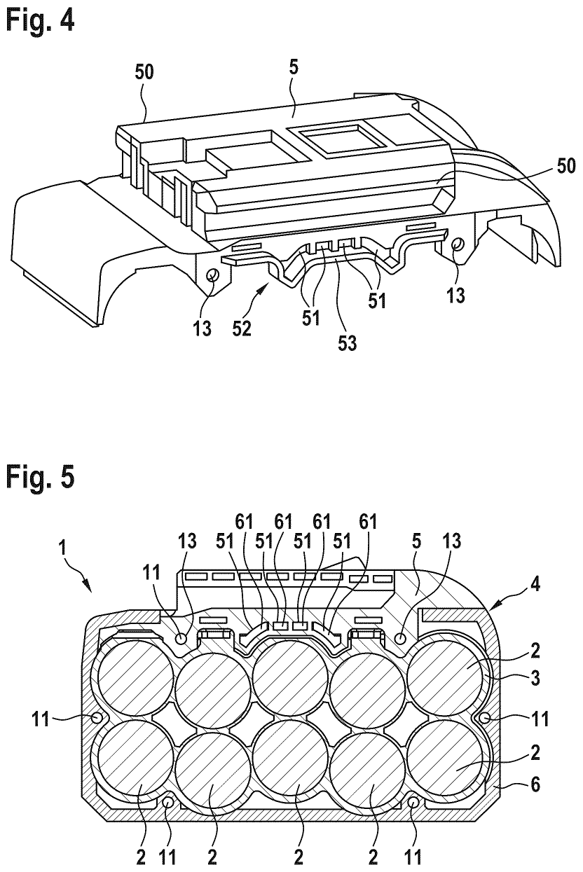

As can further be seen from FIG. 4, the cover 5 comprises a protruding edge 52 in which a plurality of second openings 51 (second interlocking elements) are formed. A cross section of the second openings 51 is the same as a cross section of the first openings 31 in the heat sink element 3. The protruding edge 52 of the cover 5 also protrudes perpendicularly from a base surface of the cover.

The first side part 6, as shown in FIG. 3, has a protruding element 60 (first interlocking element) on a cover inner side 62. The protruding element 60 comprises a plurality of ribs 61. The ribs 61 protrude perpendicularly from a cover inner side 62 towards the interior of the battery cell assembly 1. As can be seen in detail from FIG. 3, a cross section of the ribs 61 is complementary to the cross sections of the first and second openings.

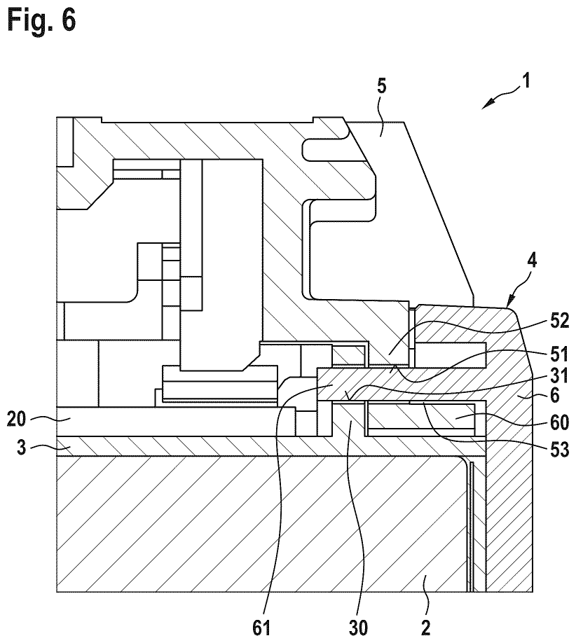

In the assembled state of the battery cell assembly 1, which is shown in FIGS. 5, 6 and 7, the protruding element 60 on the first side part 6 can thus be first be passed through the second opening 51 of the cover 5 and then passed through the first opening 31 on the heat sink element 3 (see FIG. 6).

On the protruding edge 51 of the cover 5, an undercut 53 is also formed, which protrudes towards the first side part 6 (see FIGS. 4 and 6).

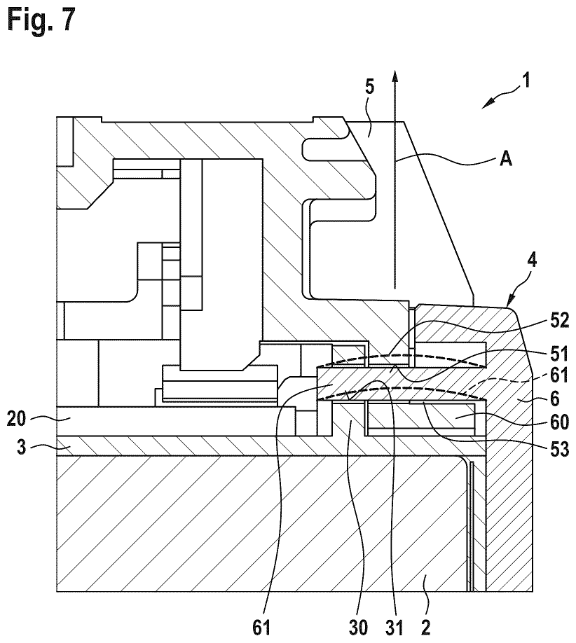

If a tensile load now acts on the battery cell assembly 1, e.g. by dropping it, the tensile load can be exerted on the connection as indicated by the arrow A in FIG. 7 by the connection according to the disclosure between the cover 5, the first side part 6 and the heat sink element 3, starting from the rest position shown in FIG. 6. As a result, the ribs 61 can bend as indicated in FIG. 7 by the dashed lines. However, as described above, the ribs 61 are substantially positively locked in both the first opening and the second opening. This results in a significant resistance to the tensile load A, which is then distributed on both the cover 5 and the heat sink element 3. This prevents the ribs 61 from breaking and the housing 4 of the battery cell assembly 1 from popping up. In addition, due to the provided undercut 35 at the protruding edge 52, there is a further distribution of force in the connection between the first side part 6 and the cover 5 as well as the heat sink element 3. The undercut 53 also allows for easy insertion of the ribs 61 into both the second opening 51 and then the first opening 31.

In addition to the connection described above between the heat sink element 3, the housing parts and the cover 5, a screw connection 10 for the battery cell assembly 1 is provided. The screw connection 10 connects the heat sink element 3 to the first side part 6 and the cover 5 and the heat sink element 3 to the second side part 7 and the cover 5.

The screw connection 10 can be seen in detail in FIGS. 1 and 5 and comprises a plurality of screws 11. A first screw opening 12 is provided in the first side part 6. A second screw opening 13 is provided in the cover 5 and a third screw opening 14 is provided in the heat sink element 3. The screws 11 are guided through the first, second, third screw openings 12, 13, 14. Thus, additional security of the connection between the components is achieved. It should be noted that the second side part 7 is fixed in the same way by a plurality of screw connections 10.

The second side part 7 of the housing 4 is fixed to the battery cell assembly 1 in the same way as the first housing part 6 so that a detailed description of this fixing can be omitted.

The connection according to the disclosure between the heat sink element 3, the cover 5 and housing parts 6, 7 thus allows a significant increase of robustness of the battery cell assembly. In particular, a secure connection can be achieved by nesting of fixation elements. In this case, the connection is adhesive-free, so that costs can be minimized by eliminating the need for an adhesive and reducing the number of assembly steps. Furthermore, a plurality of screw connections is additionally provided for additional, redundant fixation of the components. Overall, this results in a significant improvement in the quality of the battery cell assembly 1, which can withstand falls from greater heights without damage.

The battery cell assembly 1 is preferably assembled such that the battery cells are first provided with the heat sink element 3 surrounding the battery cells at the circumference of the battery cells. The cover 5 is then placed on the heat sink element 3 and the two side parts 6, 7 with the ribs 61 are passed through the first and second openings. This is followed by a screw connection.

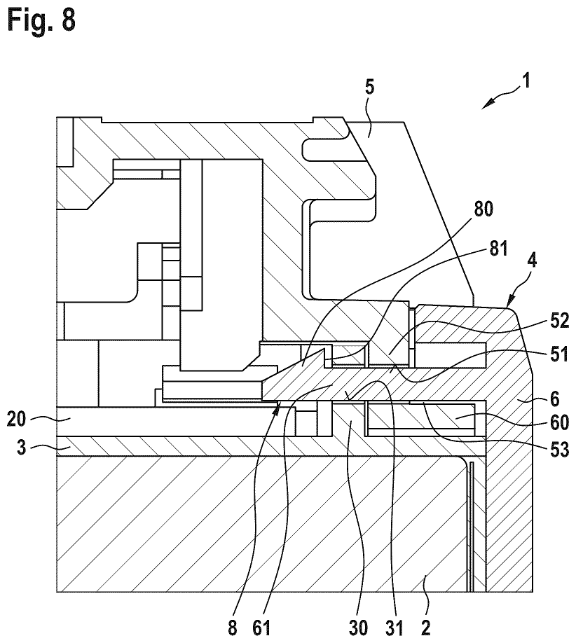

FIG. 8 shows a battery cell assembly with a component connection according to a second exemplary embodiment of the disclosure. The second exemplary embodiment substantially corresponds to the first exemplary embodiment, wherein, in addition to the first exemplary embodiment as shown in the figure, a latching connection 8 is arranged on the ribs 61 at a free end of the ribs. The latching connection 8 comprises a latching lug 80 having an undercut 81. The undercut 81 engages behind the protruding flange 30 on the heat sink element 3 in an assembled state as shown in FIG. 8. Thus, additional security of the component connection of the battery cell assembly may be achieved. Preferably, the latching connection 8 is provided on each rib 61. As in the previous exemplary embodiment, the configuration is identical on the second side part 7, which is not shown in FIG. 8.

What is claimed is:

1. A battery cell assembly, comprising:
at least one battery cell;
a cell holder element configured to at least partially enclose the battery cell; and
a multi-part housing configured to receive the battery cell, wherein the housing comprises at least a first housing part and a second housing part,
wherein the first housing part comprises a first interlocking element, the second housing part comprises a second interlocking element, and the cell holder element comprises a third interlocking element which are configured to form an interlocking connection with each other, and
wherein at least one of the interlocking elements is configured as a protruding interlocking element, and wherein the protruding interlocking element engages in the two other interlocking elements.

2. The battery cell assembly according to claim 1, wherein at least one of the interlocking elements comprises a reinforcing element.

3. The battery cell assembly according to claim 1, wherein:
the cell holder element as the third interlocking element comprises a protruding flange with a first opening and the second housing part comprises a second opening, and
the first housing part comprises a protruding element formed complementarily to the first opening and the second opening as a first interlocking element, which is received in the first opening and in the second opening.

4. The battery cell assembly according to claim 3, wherein:
the first opening on the protruding flange of the cell holder element is a polygonal through-opening, and/or
the second opening on the second housing part is a polygonal through-opening.

5. The battery cell assembly according to claim 2, wherein a cross section of the first opening is equal to a cross section of the second opening.

6. The battery cell assembly according to claim 1, wherein at least one guide rail is arranged on the second housing part, which is configured for connection to an electrical device.

7. The battery cell assembly according to claim 1, wherein the protruding interlocking element comprises a rib.

8. The battery cell assembly according to claim 1, wherein the second housing part comprises a protruding edge in which the second opening is formed.

9. The battery cell assembly according to claim 8, wherein the protruding edge comprises an undercut which is arranged between the cell holder element and the first protruding interlocking element of the first housing part.

10. The battery cell assembly according to claim 1, further comprising a latching connection formed at a free end of the first protruding interlocking element and the cover and/or the cell holder element.

11. The battery cell assembly according to claim 1, wherein a screw connection is provided between the first housing part and the second housing part.

12. The battery cell assembly according to claim 1, further comprising a third housing part which is configured to correspond to the first housing part.

13. The battery cell assembly according to claim 1, wherein the first housing part, the cell holder element, and/or the second housing part or parts thereof are made of different materials.

14. The battery cell assembly according to claim 1, wherein a distance of the second interlocking element to a guide region on the second housing part is at most five times the height of the second interlocking element.

15. The battery cell assembly according to claim 1, wherein:
the first housing part is a side part, and
the second housing part is an interface housing part or a cover.

16. The battery cell assembly according to claim 1, wherein the second interlocking element is configured as the protruding interlocking element.

17. The battery cell assembly according to claim 2, wherein the reinforcing element is a reinforcing insert.

18. The battery cell assembly according to claim 12, wherein the third housing part is a second side part.

19. The battery cell assembly according to claim 13, wherein the different materials are different plastic materials.

20. The battery cell assembly according to claim 14, wherein the distance of the second interlocking element to the guide region on the second housing part is at most 30 mm.
